(19) United States
(12) Patent Application Publication
(10) Pub. No.: US 2019/0244545 A1
(43) Pub. Date: Aug. 8, 2019

(54) NOVEL VISIBLE DEVICE FOR DEMONSTRATING PROOF OF INSURANCE COVERAGE FOR A MOTORIST AND/OR MOTOR VEHICLE WHICH IS OVERTLY VISIBLE ON OR FROM A MOTOR VEHICLE OR ANY OF ITS COMPONENTS

(71) Applicant: Timothy Francis Cronan, Centennial, CO (US)

(72) Inventor: Timothy Francis Cronan, Centennial, CO (US)

(21) Appl. No.: 15/890,480

(22) Filed: Feb. 7, 2018

(51) Int. Cl. G09F 3/02

(52) U.S. Cl. CPC G09F 3/02

(57) ABSTRACT

The present invention comprises a novel visible device generally consisting of a coating or adhesive decal, sticker, or label, which is imprinted with information which provides proof of insurance coverage for a motorist and/or motor vehicle. In preferred embodiments, the various elements will display a notation for a Month, Year, and portion of an Insurance Policy Number to display current and in-force insurance coverage. In preferred embodiments, the present invention will be constructed of a material which contains enough adhesive material to adhere to a motor vehicle or any of its interior or exterior components and a material which is durable enough to remain visible to a reasonable person at least while the insurance policy is considered to be in-force.

### FIELD OF THE INVENTION

The present invention relates to novel visible devices and apparatuses for demonstrating proof of insurance coverage for a motorist and/or motor vehicle which is overtly and/or outwardly visible on the interior or exterior of a motor vehicle. More particularly the invention relates to a visible device which is attached to a motor vehicle and provides proof of insurance coverage for a motorist which is overtly visible on the interior or exterior of a motor vehicle to a reasonable person.

### BACKGROUND

Proof of insurance coverage is compulsory in many states in the USA. This proof of insurance coverage may include a card carried by a motorist or a card placed in the interior of a vehicle. This proof of insurance may lapse, be cancelled, or be forgotten by the motorist within their vehicle or on their person.

Recently, states have enacted a process whereby a motorist must provide proof of insurance coverage to obtain compulsory motor vehicle registration. This vehicle registration is overtly visible and states the period of motor vehicle registration overtly to a reasonable person. However, the same motorist is not able at present to overtly display visible proof of insurance coverage on the interior or exterior of the motor vehicle they operate.

Certain devices have been developed for the purposes of providing proof of insurance coverage and at present none are designed to display overtly visible proof of insurance coverage on the interior or exterior of a motor vehicle to a reasonable person. The drawbacks of the current devices are that, while they are compulsory, they are hidden from overt view by a reasonable person. This results in an inability for a motor vehicle operator to overtly display compliance with compulsory motorist insurance coverage laws and regulations for a reasonable person to view.

Therefore, a need exists in the field for a novel device for demonstrating proof of insurance coverage for a motorist and/or motor vehicle which is overtly visible when attached to a motor vehicle or any of its components.

### BRIEF SUMMARY OF THE INVENTION

The present invention comprises a novel device generally consisting of at least one adhesive device including any sticker, label, coating, lamination, cling, patch, chip, tag, plate, painted device, coated device, electrical device, non-electrical device, magnetic device, method, or other device affixed or by any method attached to a Motor Vehicle or any component of or component attached to the motor vehicle. In preferred embodiments, the various elements of the novel visible device for demonstrating proof of insurance coverage for a motorist on the exterior of a motor vehicle will generally consist of an adhesive material or adhesive or magnetic sticker to be placed on a vehicle or any component of the vehicle, including an attachment to the state mandated registration plate on the rear of the motor vehicle and in a location not obscuring any alpha-numeric portion of the state mandated registration plate on the vehicle.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a perspective view of one example of the present invention demonstrating proof of insurance coverage for a motorist per various embodiments of the present invention.

FIG. 2 depicts a perspective view of one example of the present invention demonstrating proof of insurance coverage for a motorist per various embodiments of the present invention described herein.

FIG. 3 depicts a perspective view of one example of the present invention demonstrating proof of insurance coverage for a motorist per various embodiments of the present invention described herein.

FIG. 4 depicts a perspective view of one example of the present invention demonstrating proof of insurance coverage for a motorist per various embodiments of the present invention described herein.

### DETAILED DESCRIPTION OF THE INVENTION

The terminology used herein is for the purposes of describing particular embodiments only and is not intended to be limiting of the invention. As used herein, the term “and/or” includes any and all combinations of one or more of the associated listed items. As used herein, the singular forms “a”, “an”, and “the” are intended to include the plural forms as well as the singular forms, unless the context clearly indicates otherwise. It will be further understood that the terms “comprises” and/or “comprising”, when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that several techniques and steps are disclosed. Each of these has individual benefit and each can also be used in conjunction with one or more, or in some cases, all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Visible Devices for Demonstrating Proof of Insurance Coverage for a Motorist are discussed herein. In the following description, for purposes of explanation, numerous specific details are set forth to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or descriptions herein.

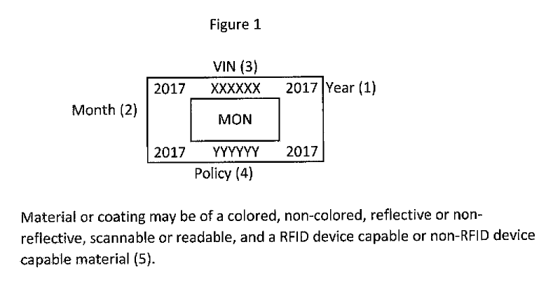

The present invention will now be described by referencing the appended figures representing preferred embodiments. FIG. 1 depicts a front view of the present invention and aside from sizing differences, represents a view a reasonable person might expect when viewing the present invention from the most common view. The outer corners of FIG. 1 display an example of a Year (1) of a motorist's insurance coverage and/or renewal, and the center of FIG. 1 displays an abbreviation of a Month (2) of coverage and/or renewal. The top-center displays a representation of the last 6 alpha-numeric digits (3) and may contain more or fewer, numbers or digits of a motorist's Vehicle Identification Number (VIN). The bottom-center displays a representation of the last 6 alpha-numeric digits (4), and may contain more or fewer, numbers or digits of a motorist's insurance coverage policy number. In general terms the present invention may be of a colored, non-colored, reflective or non-reflective, scannable or readable, and a RFID device capable or non-RFID device capable material (5).

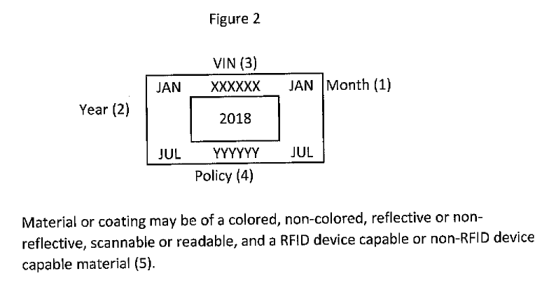

FIG. 2 Depicts a front view of the present invention and aside from sizing differences, represents a view a reasonable person might expect when viewing the present invention from the most common view. The outer corners of FIG. 2 display an example of a Month (1) of a motorist's insurance coverage and/or renewal, and the center of FIG. 2 displays an example of a Year (2) of a motorist's insurance coverage and/or renewal. The top-center displays a representation of the last 6 alpha-numeric digits (3) and may contain more or fewer, numbers or digits of a motorist's Vehicle Identification Number (VIN). The bottom-center displays a representation of the last 6 alpha-numeric digits, and may contain more or fewer, numbers or digits of a motorist's insurance coverage policy number (4). In general terms the present invention may be of a colored, non-colored, reflective or non-reflective, scannable or readable, and a RFID device capable or non-RFID device capable material (5).

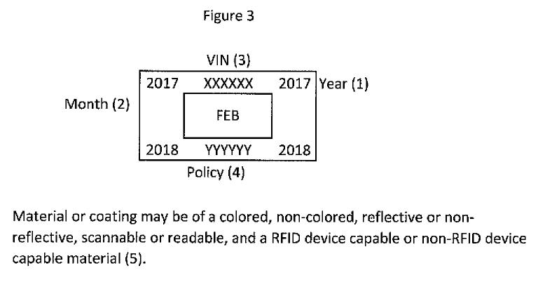

FIG. 3 Depicts a front view of the present invention and aside from sizing differences, represents a view a reasonable person might expect when viewing the present invention from the most common view. The outer corners of FIG. 3 display an example of a Year of a motorist's insurance coverage (1), and the center of FIG. 3 displays an abbreviation depicting a Month-to-Month type of insurance coverage (2). The top-center displays a representation of the last 6 alpha-numeric digits (3) and may contain more or fewer, numbers or digits of a motorist's Vehicle Identification Number (VIN). The bottom-center displays a representation of the last 6 alpha-numeric digits, and may contain more or fewer, numbers or digits of a motorist's insurance coverage policy number (4). In general terms the present invention may be of a colored, non-colored, reflective or non-reflective, scannable or readable, and a RFID device capable or non-RFID device capable material (5).

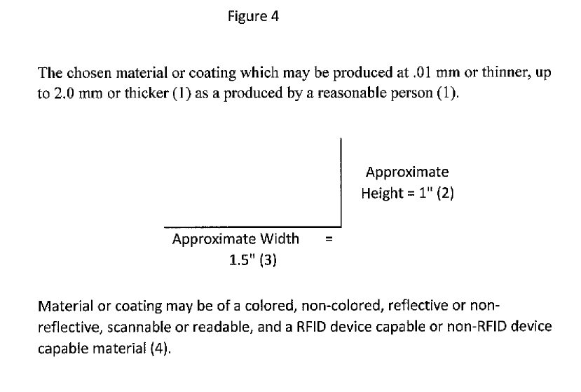

FIG. 4 is a representation of the present invention with the emphasis on the thickness and sizing of the material as represented by the lines and arrows in the figure. The present invention, based on the required/chosen material which may be produced at 0.01 mm or thinner, up to 2.0 mm or thicker (1) as a produced by a reasonable person. The present invention is displayed at a height of one-inch (1″) (2), and a width of one-and-one-half-inch (1.5″) (3) and may vary in size as produced by a reasonable person.). In general terms the present invention may be of a colored, non-colored, reflective or non-reflective, scannable or readable, and a RFID device capable or non-RFID device capable material (4).

In preferred embodiments the present invention will be constructed of an adhesive material with a removable backing, as a coating or laminated material, or as a magnetic device. The present invention would be referred to as a label, sticker or magnet by a reasonable person. Other designations of the present invention would be referred to as a label, decal, coating, laminate, cling, tag, badge, button, identification, marker, chip, insignia, stamp, logo, hallmark, mark, or emblem by a reasonable person.

In preferred embodiments, the present invention, herein referred to as a sticker, coating, or magnet, and will consist of a sticker of vinyl or polyvinyl chloride (PVC) material, or other material, and may contain a backing which may be peeled away and discarded or consist of a magnetic substance. The material for this coating, sticker or magnet may be transparent, opaque, reflective, non-reflective, scannable or readable, and may or may not contain any type of Radio Frequency Identification Device (RFID) embedded within, on, or under the material used to create the sticker or magnet.

The sticker, coating, or magnet will be printed, marked, laminated, etched, or created by a reasonable person skilled in the art of creating the present invention with alpha-numeric characters in a fashion which is similar but not limited to the attached drawings (FIGS. 1-4).

Although the present invention has been illustrated and described herein regarding preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are thereby contemplated, and are intended to be covered by the following claims.

What is claimed is:

1. A visible device for demonstrating proof of insurance coverage for a motorist and/or motor vehicle when adhered or attached to the interior or exterior of a motor vehicle or any of its components comprising:
a. A coating, laminated, or printed sticker with alpha-numeric text sufficient to be visible to a reasonable person.
b. Various coated, laminated, or printed styles which may display different types of insurance coverage for a motorist and/or motor vehicle.
c. Various coated, laminated, or printed sizes which may display different types of insurance coverage for a motorist and/or motor vehicle.

2. A visible device for demonstrating proof of insurance coverage for a motorist and/or motor vehicle and is designed to be used and considered to be in-force for a period of time which coincides with the period of insurance coverage for the motorist or motor vehicle and is not meant to be transferable or duplicated for use in any method other than which it is designed.
a. Materials comprising the present invention are intended to be transferred or copied or used with multiple motor vehicles at the same time.
